(19) United States
(12) Patent Application Publication
(10) Pub. No.: US 2022/0339546 A1
(43) Pub. Date: Oct. 27, 2022

(54) REMOTE VEHICLE RACING CONTROL AND ELECTRONIC GAMING SYSTEM

(71) Applicant: AVICAR, Inc., New York, NY (US)

(72) Inventors: Courtney Brown, New York, NY (US); Andrew Goor, New York, NY (US); Christopher Brown, New York, NY (US)

(21) Appl. No.: 17/730,066

(22) Filed: Apr. 26, 2022

Related U.S. Application Data
(60) Provisional application No. 63/179,774, filed on Apr. 26, 2021.

(51) Int. Cl. A63F 13/803; A63F 13/35

(52) U.S. Cl. CPC A63F 13/803; A63F 13/35

(57) ABSTRACT

The present method and system provides for network-based remote control racing, including receiving a user inputs accessing a gaming engine via user interfacing modules running on a mobile computing device. The method and system includes connecting the gaming engine with a vehicle control engine in response to the user inputs. Via the vehicle control engine, engaging remote control vehicles associated with separate users, wherein the remote control vehicles are physically disposed within a race course. The method and system generates vehicle control commands to control the remote-control vehicles based on the user inputs. Based thereon, the users physically race remote-control vehicles across a communication network. Included herewith, the gaming engine not only facilitates the racing, but distributes the racing content to the users, as well viewers actively watching the physical race.

### RELATED APPLICATIONS

The present application claims priority to U.S. Patent Application Ser. No. 63/179,774 entitled “REMOTE VEHICLE RACING CONTROL AND ELECTRONIC GAMING SYSTEM” filed Apr. 26, 2021 and incorporates its disclosure herein by reference.

### COPYRIGHT NOTICE

A portion of the disclosure of this patent document contains material, which is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### FIELD OF INVENTION

The disclosed technology relates generally to network-based electronic sports competition platforms and more specifically to an online gaming platform for competing and viewing real-world remote-controlled competitions.

### BACKGROUND

Electronic gaming platforms, also referred to as e-sports, continue to emerge. While there are numerous e-sports platforms, including professional and amateur leagues, the existing platforms focus on playing video games. Whereas, e-sports and user interactions with real, live, activities is nascent to non-existent.

One current example of remote-based live activities is available from Surrogate, a Finnish company creating remote control technologies. Surrogate technology is about network-based remote user control of machinery. One example of the Surrogate technology appears to use the network-based remote control allowing for users to physically race small battery-operated racing cars.

As understood, the Surrogate technology builds upon their remote control technology, simply transferring remote control instructions to a central node and transmitting video back to the user. The Surrogate technology can allow multiple users to control different vehicles, thus engaging in a race. Nothing within the Surrogate technology provides for an e-sports platform.

An example of the Surrogate technology focusing on remote-based vehicle control is the video feedback as part of the user interaction. The Surrogate technology uses a fixed bird's-eye view of the racing track. This creates a skewed and shifting viewpoint for the users controlling the vehicles as the vehicles turn around the track, this alters the left/right/up/down orientation for vehicle controls.

Isotopium: Chernobyl is another version network-based remote control technology. This technology does not include racing or an e-sports platform, but instead is a slow-moving object (a tank) navigated by the user through a physical environment.

The current solutions offer solely the ability to translate user navigation controls (forward, break, turn right, turn left) into network-based transmissions and deliver to a physical moveable object. None of the solutions provide for e-sports competitions, including managing data flow associated with multiple players, managing multiple competitions, managing user and viewer experiences, among other elements.

There are no current solutions incorporating networked-based remote control functionality for virtual real-world competitions and including an online central gaming platform for not only viewing the competitions, but managing teams, players, leagues, and other features for a complete online e-sports/racing environment.

### BRIEF DESCRIPTION

The present invention overcomes the prior art limitations for e-sport activities by providing a network-based remote control racing system. The system includes a gaming engine disposed within a data exchange network, for example the Internet. The system includes a vehicle control engine in communication with the gaming engine via the data exchange network.

The vehicle control engine is a remotely-located processing engine being in wireless communication with remote control vehicles. The remote control vehicles are physical devices disposed within a race course with communication hardware and/or software to interaction with users controlling the vehicles across the data exchange network.

The remote control racing system includes a first user interfacing (UI) module running on a first mobile computing device. The UI module is in electronic communication with the gaming engine via the data exchange network.

Similarly, the remote control racing system includes a second user interfacing (UI) module running on a second mobile computing device. This UI module is also in electronic communication with the gaming engine via the data exchange network.

The gaming engine is centrally-located via the network for managing user communications and remote-control racing instructions. The gaming engine receives first user input commands from a first user via the first user interfacing module and therein transmits the first user input commands to the vehicle control engine across the data exchange network. The gaming engine also receives second user input commands from a second user via the second user interfacing module, therein transmitting the second user input commands to the vehicle control engine across the data exchange network.

The vehicle control engine receives the first vehicle control commands and transmits those control commands to a first remote control vehicle. The vehicle control engine also receives the second vehicle control commands, transmitting those control commands to a second remote control vehicle. As needed, the vehicle control engine may translate or transform the control commands from user input commands to vehicle control instructions.

By the vehicle control engine receiving the vehicle control commands and then instructing the remote control vehicles, all done across the data exchange network, the first user and the second user are electronically engaged and both virtually and physically race each other by racing actual vehicles within the race course. The vehicle control commands are transmitted across the data exchange network. The vehicle control commands and racing activities are all being processed through the centrally-located gaming engine.

The remote control racing system further includes a racing content module including executable instructions for capturing racing content of the remote control vehicles. Capture of the racing content can be via cameras disposed on the vehicles, cameras located around the track, cameras and/or microphones associated with the users individually or teams associated with the users, data sensors, or any other content capturing device or devices. This racing content is then distributed to the gaming engine across the data exchange network.

Additionally, the racing system includes gaming display modules in networked communication with the gaming engine. The gaming display modules can be any suitable software application allowing for viewing of the racing activity, for example a web-based viewer application, a stand-alone viewer executable, etc. In another embodiment, content can be livestreamed and/or recorded for later distribution, such as an on-demand content distribution system.

The system includes a gaming content distribution module disposed within the gaming engine. The distributing module receives the racing content from the content capture module and transmits the racing content to gaming display modules. The gaming content distribution module may include supplementary or complimentary content, for example advertisement, team data, user generated content, merchandising content, etc. Therein, user can remotely watch racing activities via the gaming display modules.

In one embodiment, the remote-control racing system includes vehicle tracking modules. The modules capture movement data for each of the vehicles. These tracking modules collect various data points usable for the users controlling the vehicle. For example, movement data can include camera-captured images from cameras mounted within, on top of, and/or around the vehicle. The movement data can include engine sensor data or other vehicle information, such as speed, battery-life, lap time, distance to competing vehicles, etc.

Via the gaming engine, the users are presented with the movement data for their corresponding vehicle, such as shown within the user interfacing module. The user input commands are based on the movement data, providing for network-based real-time control and management of the physical remote-control vehicle.

In one embodiment, the gaming engine facilitates team competitions and management of racing teams or leagues for various competitions. A team content database can communicate with the gaming engine, the team content database has team content data stored therein. In one embodiment, the team content data may include graphics, logos, or other team identifiers for associating with the remote control vehicle. For example, the vehicles may be generic vehicles, where users select or assigned a vehicle. Thus, the content data may include an image that is uploaded and viewable on the remote control vehicle. In one embodiment, the image may be a non-fungible token (NFT) owned by the team, with appropriate digital rights management functions facilitating distribution of the imagery to the vehicle.

The racing system provides for racing any physical device capable of being remotely controlled. One embodiment may be racing physical remote-controlled cars. But that embodiment is not an expressly limiting embodiment, as racing can be any other suitable vehicle including but not limited to boats, drones, planes, etc. In further embodiments, remote control is not expressly limited to or solely associated with high-speed racing, rather varying remote control embodiments can be finesse or controlled movement options, such as high precision movement. Therefore, as used herein, remote control vehicles generally refer to any vehicle, element, device, or processing module that can be remotely controlled by users across the data exchange network.

Herein, the present method and system overcomes the prior art limitations of remote vehicle control with integrating at least one gaming engine and additional processing functionality for not only remote-based vehicle control, but also distributing racing content back to the users and gaming content to viewers watching the remote activity.

### BRIEF DESCRIPTION OF THE DRAWINGS

FIG. 1 illustrates a block diagram of a system for network-based remote vehicle control with a gaming platform;

FIG. 2 illustrates a block diagram of various user interface processing modules;

FIG. 3 illustrates a block diagram of one embodiment of a remote controlled vehicle;

FIG. 4 illustrates a flowchart of the steps of one embodiment of a method for network-based remote vehicle control with a gaming platform; and

FIG. 5 illustrates a flowchart of the steps of one embodiment of content distribution of remote vehicle control/racing.

A better understanding of the disclosed technology will be obtained from the following detailed description of the preferred embodiments taken in conjunction with the drawings and the attached claims.

### DETAILED DESCRIPTION

The method and system herein provides for network-based remote control of vehicles, with user interfacing functionality operated through a gaming platform. Users manually control vehicles for engaging in racing or other competitions, the engagement operating through the gaming platform to facilitate an e-sports environment beyond mere vehicle control.

The e-sports environment/platform includes user interfacing gaming operations, spectator visuals, league and/or other competition-based statistics, and the general platform for gaming and content engagement. The e-sports environment further allows for additional commercial engagements, including managing and tracking user behaviors, associating media and/or advertising content, content distribution via livestream and on-demand content, among other engagements.

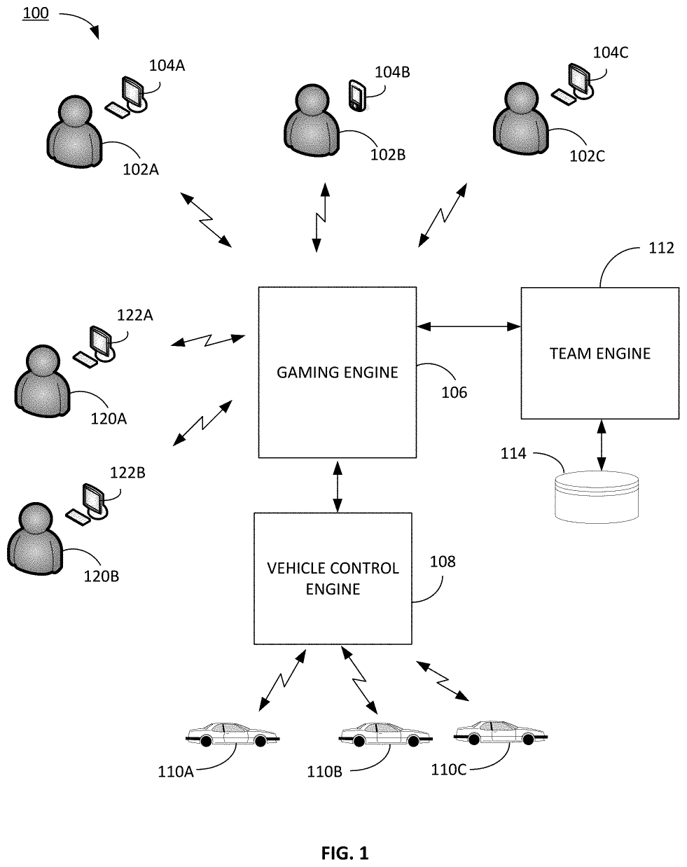

FIG. 1 illustrates a processing environment 100 with multiple users 102A-102C, each having local processing devices 104A-C. The system 100 includes a gaming engine 106, a vehicle control engine 108, and a plurality of remote control vehicles 110A-110C. The system 100 additionally includes a team engine 112 and a team database 114, as well as viewers 120A-120B engaging local processing devices 122A-122B.

FIG. 1 illustrates 3 exemplary users 102, but it is recognized the system 100 can operate with any number of users. The users engage local processing devices 104, the devices having executable instructions running thereon. The devices 104 communicate with the gaming engine 106 across one or more networked connections. For example, one embodiment may be via an Internet or other network-based connection. In another embodiment, connection may be via multiple networks, such as a mobile device connecting via a wireless network, connecting to the Internet. The devices 104 engage the gaming engine 106 using known communication techniques and protocols.

The processing devices 104 can be any suitable device operative to connect with the gaming engine 106. For example, the devices can be laptop or desktop computers, mobile phones, tablet computers, gaming consoles, television set-top boxes, virtual reality (VR) headsets and/or VR systems, augmented reality (AR) headsets and/or AR systems, or any other suitable computing device providing for user interactions as noted herein. In further embodiments, the processing devices 104 can include combination of devices, for example, but not expressly limited to, a VR headset in operation with a desktop computer.

The gaming engine 106 may be one or more networked-based processing device or devices. For example, in one embodiment the gaming engine may be a cloud-based executable running on one or more servers disposed in a distributed network. In another embodiment, the engine 106 may be a locally executed server or servers managing content flow across the data exchange network. In another embodiment, the gaming engine 106 may be integrated into or complimentary with another gaming platform or content distribution platform.

The vehicle control engine 108 is a gateway processing device or devices communicating with the remote control vehicles 110. In one embodiment, the vehicle control engine 108 is disposed local to the vehicles 110. For example, if the vehicles are disposed in a race track in New York City, the gaming engine 106 may be network-based but the vehicle control engine 108 is located at the race track itself in New York City. The proximity of the vehicle control engine 108 to the vehicles 110 reduces or eliminates delay, lag, or other processing incongruencies for managing real-time vehicle control. In another embodiment, the vehicle control engine 108 may include both network-based processing functionality and one or more local transmitters/receivers to relay information to/from the vehicles 110.

The team engine 112 may be one or more network-based processing engine(s) for providing team functionality with the gaming engine 106. The database 114 can store team data as usable in the present method and system, including team log-in details, team logos and imagery, team statistics and team data, by way of example.

The viewers 120A-120B can be any suitable viewer using the processing device 122A-122B to view the gaming activity. FIG. 1 illustrates 2 sample viewers, but it is recognized the system operates with any number of viewers, which can be geographically dispersed viewing via the network-connectivity. Similar to the devices 104A-104C, devices 122A-122B can be any suitable processing device herein providing for viewing gaming content. The devices 122A-122B communicate across one or more networked connections and can use any suitable communication technique to receive gaming content distributed by the gaming engine 106.

The vehicle control engine 108 can represent control for a single racetrack with a predetermined number of remote-controlled vehicles 110. The system 100 can include any number of concurrently operating engines 108 in any number of different locations, being accessible via the network. For example, the system can include 5 different vehicle control engines controlling cars or other vehicles for racing in five separate race tracks at different geographic locations or multiple tracks or circuits within a single track or arena.

In one embodiment, users and/or teams can be compete in a series of races, such as a circuit, across multiple track locations, a virtual grand-prix style racing series. Herein, team data 112 can include racing information and/or statistics usable for managing the multiple races and distributing team or user content to viewers viewing the multiple races. In one embodiment, the races can occur on a regular basis such as once a week. In another embodiment, a virtual or cloud-based grand prix series can be conducted within a single day or across consecutive days.

Various embodiments can use different numbers of vehicle control engines 108. For example, one embodiment may use one engine 108 per vehicle 110. In another embodiment, a single engine 108 can generate a multi-channel signal distributed across multiple vehicles 110. In one embodiment, a vehicle control engine 108 can be designated per vehicle, for example if there are 6 vehicles the track may include 6 separate engines 108. In another embodiment, a dedicated processing socket or dedicated communication channel can be established between the vehicle control engine 108 and the user interface to reduce or minimize network and signal processing latency concerns. In one embodiment, the vehicle control engine 108 can communicate directly with the user interface and share data with the gaming engine, to further reduce signal latency and any signal delay being processed through the gaming engine 106.

In one embodiment, the vehicles 110 include processing elements for controlling the operations of the vehicle, as well as cameras or other feedback output for the user manually operating the vehicle.

FIG. 1 illustrates the vehicle 110 as a car, but it is recognized that any suitable motorized vehicle can be used herein and the invention is not expressly limited to cars. For example, the vehicle can be a boat running on water, an airplane, drone, helicopter, or any other flying object, or any other remote-controlled object capable of being raced with other competitors.

The vehicle control engine 108 executes multi-directional communication with the vehicles 110. The engine 108 forwards user control functions, such as accelerating, braking, turning, etc. as processed through the gaming engine 106. The engine 108 can additionally process or feed the control functions back to the gaming engine 106 for racing content distribution to viewers.

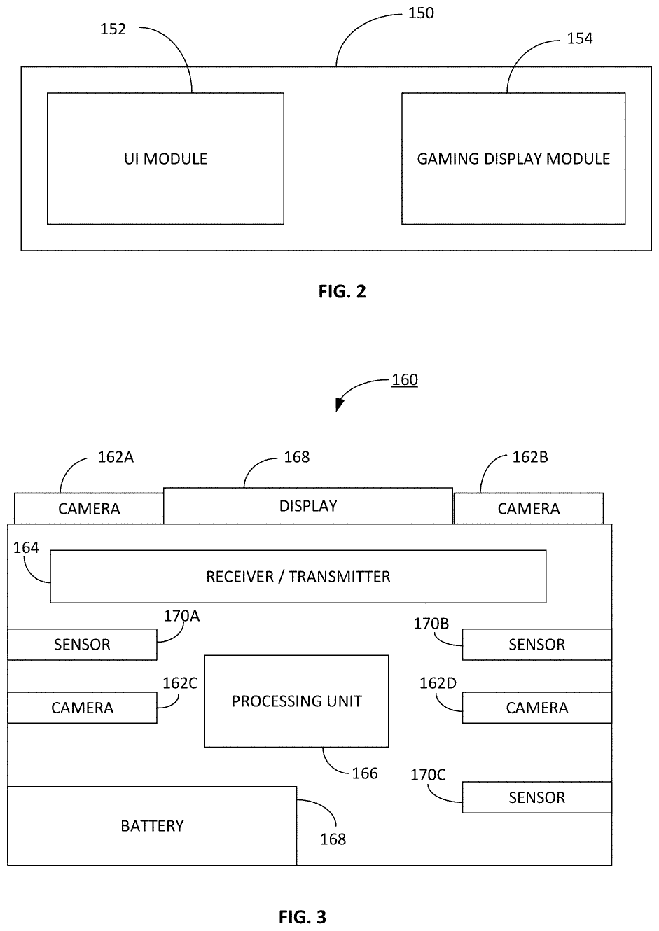

FIG. 2 illustrates one embodiment of a processing module 150 executable on the devices 104, 122 of FIG. 1. The processing module 150 includes a user interfacing (UI) module 152 and a gaming display module 154. As recognized by one skilled in the art, the processing module may include additional engines or modules, omitted for clarity and brevity purposes only.

The UI module 152 may be one or more processing modules in response to executable instructions. The module 152 can be locally-executed, networked-based execution, or a combination thereof. The module 152 can be a stand-alone processing routine/application. The module 152 may also be integrated into another interfacing program. For example, the module 152 may be executable within a web-based gaming platform or via a browser display window. In another example, the module 152 can be a downloadable app from an app store or via a web-based distribution.

The UI module 152 interacts with the user for not only receipt of gaming/racing instructions, such as a remotely connecting to and controlling a remote control vehicle, but also for receiving feedback on the actual real-world movements of the vehicle. For example, one embodiment may include the user controlling a gaming controller and watching the vehicle tracking information generated by the vehicle and/or the vehicle control engine on a computer monitor. In another exemplary embodiment, the user may be wearing a VR headset and controlling the vehicle with a driving simulator having a steering wheel and acceleration/brake pedals.

The gaming display module 154 may be any suitable viewer for viewing the racing content. In one embodiment, users racing vehicles execute the UI module 152 and spectators execute the gaming display module 154 to view the racing activities. In other embodiments, these modules 152/154 may be integrated for example if the participants are part of a team and users switch between racing via the UI module 152 and watching gaming content via the gaming display module 154.

Using networked communication protocols, the users 102 via the computing interfaces 104 control the vehicles 110 through the engine 108, as well as receive the in-vehicle feedback back to their computing devices 102. In one embodiment, the system may use a dedicated channel or socket per vehicle to maintain open communication. This open communication allows for real-time communication to minimize or avoid lag or delay, improving the user racing experience.

Control of the vehicle can use any suitable user interface functionality, including but not limited to a computer keyboard, joystick, driving simulator console, gaming controller, for example. The user controlling the vehicle engages in networked control of the vehicle by initiating local control instructions, e.g. accelerating the car and turning left. These control signals are transmitted to the vehicle control engine 108 via the gaming engine 106, subsequently instructing local motor controls of the vehicle 110.

The vehicle control engine 108 generates the vehicle control commands and transmits the vehicle control commands to the individual vehicles. The vehicle control commands are translations of the user input/control commands for controlling the vehicle. Exemplary vehicle control commands include acceleration, braking, steering, by way of example.

FIG. 3 illustrates one embodiment of a remote control vehicle 160. This exemplary embodiment illustrates various internal processing elements including cameras 162 disposed around and/or inside the vehicle 160. A receiver/transmitter 164 communicates with the vehicle control engine 108 of FIG. 1. Battery 166 provides for remote operation. In this example, the vehicle 160 includes an exterior display 168 and multiple sensors 170.

By way of example, one or more cameras 162 can provide for capturing real-time content usable by the user controlling the vehicle. For example, cameras may be mounted to the front of the vehicle, top of the vehicle, sides, and/or rear. The cameras generate imagery used to remotely control the vehicle. The camera(s) 162 transmit images eventually received by the UI module 152 of FIG. 2. The camera(s) 162 can generate and transmit images eventually received by viewers via the gaming display module 164 of FIG. 2.

The sensors 170 can be any suitable type of sensor capturing sensor data usable for controlling the vehicles and/or viewing the race. For example, a motion sensor can detect vehicle speed. In another example, a sensor can detect g-forces, braking forces, vehicle heat, battery life, distance to other vehicles, position within a race course, etc.

The display 168 can be any suitable display device or panel affixed to or integrated within the vehicle. In one embodiment, the receiver 164 can receive a user/team logo or team imagery, uploaded to the display 168. In this case, spectators viewing the race can view the logo or imagery and determine the vehicle's position in the race.

In one embodiment, the logo or imagery can be one or more non-fungible tokens (NFT). Therefore, the database 114 can include identifier information for acquiring, authenticating, and verifying use of the NFT as part of the imagery or logo. The database 114 may include authentication processing routines and/or validation executables for using and recording use of digital access across one or more distributed database networks, e.g. blockchains.

The receiver/transmitter 164 receives the vehicle control instructions and relays those instructions to control the vehicle 160. The vehicle 160 is controlled similar to known remote control vehicles, whereby the control commands are received via the networked communication, as well as generating feedback data via the cameras 162 and sensors 170 for remote control. In one embodiment, control of the vehicle can include login or other security or payment verification routines prior to the user being given operational control of the vehicle.

With reference back to FIG. 1, the vehicle control engine 108 also receives feedback from the vehicle 110, such as visual and/or audio feedback showing vehicle operations in real time. Additional feedback can include vehicle-specific information such as velocity, positioning information, distance between cars, operating features such as a battery power, etc.

In one embodiment, the vehicle may include local safety or override features and functions to protect the vehicle. For instance, if a network connection is dropped, the vehicle may engage an autopilot or other autonomous feature to avoid a collision or other damaging the vehicle. In another instance, if two vehicles are about to crash at high speed, override functions can intercept to eliminate or reduce vehicle damage.

Local vehicle instructions can include increasing the rotational speed of the wheel to accelerate, adjusting the direction of the wheels of the vehicle to create turning, dampening wheel rotation for braking, reversing the wheel rotation direction to switch into reverse, among others. Local vehicle instructions may additionally include loading and/or controlling trim and other visual representations for the vehicle, such as loading imagery such as a team logo or proprietary NFT and controlling or managing the display.

As the vehicle 110 moves, local sensors, including for example a camera and speedometer, provide feedback information back to the engine 108 and subsequently back to the user 102 via the gaming engine 106 to the user device 104. This information is also referred to as movement data captured by the vehicle tracking modules such as but not limited to camera and/or sensors.

In one embodiment, the sharing of information between the user 102/computer 104 and the vehicle 110 continues in a dedicated communication channel while the race or driving event is active. Using a dedicated channel thereby avoids or minimizes any network latency and facilitating real-time (e.g. as near to real-time as possible) vehicle control and feedback.

In addition to the remote control of vehicles across a network connection, the present invention further provides for gaming engine operations associated with and using the vehicle control functionality, as well as the racing or competitions conducted amongst users 102.

The gaming engine 106 operates both data input management and content distribution for the e-sports platform. This includes managing individual races or driving events, as well managing multiple events in conjunction with each other, and further distributing the event content to viewers, subscribers, or other recipients.

In one embodiment, the system 100 of FIG. 1 may additionally include one or more racing content module(s). These module(s) include processing instructions for capturing racing content, including but not limited to content generated by the vehicles, but can also include content acquired from the race venue, as well as additional user content. For example, the racing content module can capture the racing content of the vehicles, the racing content including the sensor and/or camera data.

The racing content modules can be disposed within or ancillary to the vehicle control engine 108, receiving the racing content from the vehicles. In another embodiment, the racing content module can be disposed within or operate concurrent with the gaming engine 106, within a networked processing environment.

The racing content module(s) capture the racing content and provide the racing content to the gaming engine 106. The gaming engine 106 includes a gaming content distribution module executable therein. This distribution module transmits the racing content to the gaming display modules running on the viewing device 122 (and in some embodiments devices 104).

Distribution of content can be via a dedicated e-sports viewing platform, may include livestream content across one or more livestream platforms, may include distribution across social media platforms or recorded content platforms, e.g., YouTube®, Discord®, Twitch®, Steam®, etc. In another embodiment, the gaming engine 106 may include a dedicated platform for hosting users 102 computing in races and users 120 view racing content, this platform can include user log-in details consistent with known techniques. In another embodiment, the gaming engine 106 can include wagering functionality or may communicate with a third-party platform providing wagering services.

In an example of an e-sports platform, users can view the racing activity occurring in real time with direct interactivity. For example, a display screen may show current racing activities from a track-level view. Viewers can switch the display to the vehicle-specific view, e.g. seeing exactly what the driver/controller sees from his or her remote location. A sidebar screen can include a running output of statistics regarding the vehicles and the overall race. A sidebar screen can also include socializing between viewers, including a chat window for viewer commentary. Another output viewable by the viewers can be a camera capturing the users (102) in real time controlling/navigating their specific vehicles around the racetrack.

Users 120 can access the gaming engine 106 via the separate computing devices 122, not for controlling vehicles but for watching gaming content.

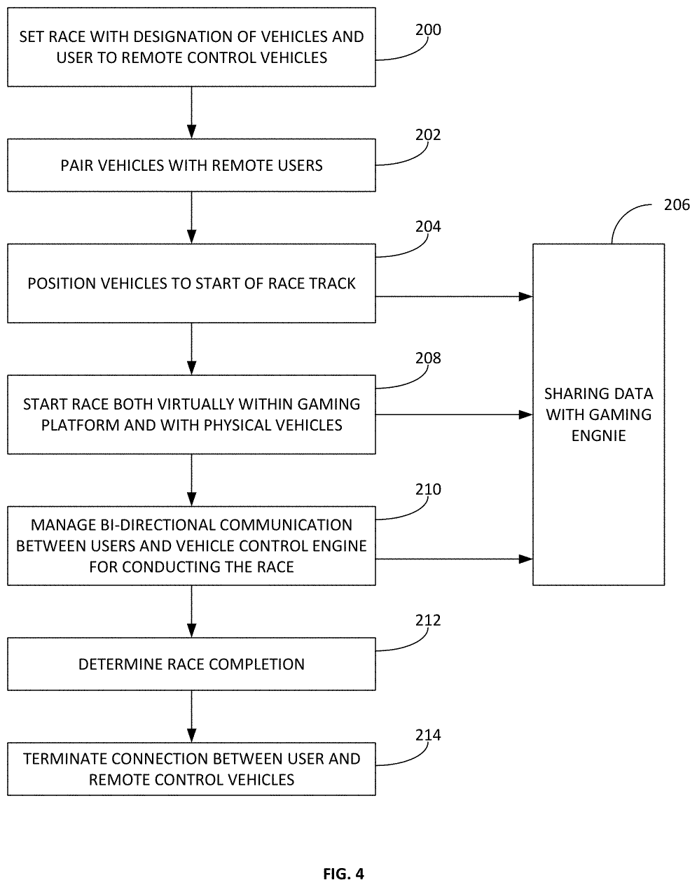

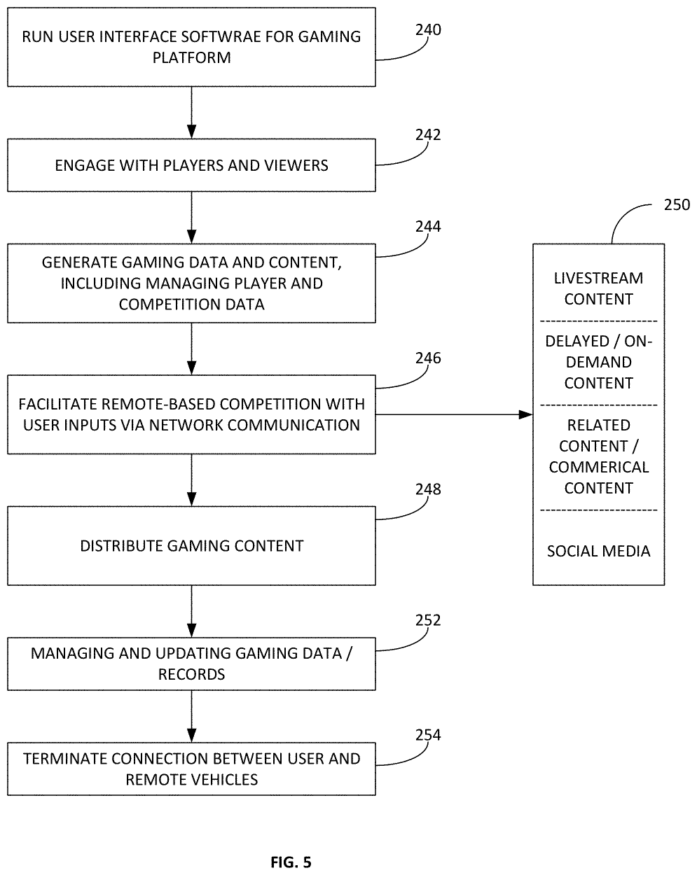

FIG. 4 illustrates one embodiment of data flow diagram for managing vehicle control, including in conjunction with the gaming engine. Step 200 is to establish a race with designating vehicles and users controlling the vehicle.

This step can include users logging into or joining a gaming engine via login or other user interface functions. The users can be remotely located relative to each other and the gaming engine. In another embodiment, the users can be centrally located, such as within an arena or other centralized location. Users can log in using gaming handles, team names, or other identifiers and the gaming engine may include various gaming engine operations, including social and data management operations.

In one embodiment, users may have designated vehicles, such as proprietary vehicles either bought, rented, or on loan at the physically-distant racing location. In another embodiment, a general selection of vehicles can be made available, users selecting or otherwise being assigned vehicles for racing. In another embodiment, users and/or teams of users can create, uploaded, or otherwise make available imagery and other content for display with the team and/or vehicles, for example loading a team logo, imagery of a team mascot, sponsor logo(s), NFT content, among others.

In step 202, the users are paired with the vehicles. For user-specific vehicles, this can include designating within the gaming engine that the user has activated the vehicle, is engaging in a selected race, and the vehicle is prepared for competition. This pairing can additionally include monitoring and tracking interactive information between the user and the vehicle, as well vehicle-specific information arising during the race itself.

Step 204 is to position vehicles to the start of race track. Step 204 can be an automated processing routine with the vehicle control engine instructing the vehicle to the proper starting position. Step 204 can also be a manual operation with a race director placing different vehicles at different locations.

Concurrent with step 204, step 206 is sharing the race data with the gaming engine. This can include physical data, e.g. gps data, engine operations data, etc., along with racer data, e.g. name, rank, team name, etc., and further data such as visual data from one or more various cameras associated with the vehicle, user, track, etc.

Step 208 is to start the race both virtually within the gaming platform and with the physical vehicles. This operation can include releasing any electronic hold features on the vehicles, to prevent false starts. The users manually instruct the vehicles to move, the user controls are transferred across the network and to the appropriate vehicles through the vehicle control engine.

The racing data is also additionally shared with the gaming engine, step 206.

Step 210 is to manage bi-directional communication between the users and the vehicle control engine for conducting the race. The vehicle feedback information, e.g. camera displays, are sent in real-time to the user controlling the vehicle with the user controls being concurrent sent to the vehicle itself.

This communication data can also be shared with the gaming engine, allowing for the engine to track available data, as well as make data available for viewers watching the race, whether it be in real-time or on a delayed/on-demand environment.

Step 212 is to determine the completion of the race. In a typical race, that may be completion of a set number of laps. In another race, this can be completion of a timed event, such as racing for a period of 5 minutes. Completion of the race includes additional gaming and e-sports data, including winner and loser statistics.

Step 214 is to then termination the connection between the user and the remote vehicle. Remote vehicle can include returning to storage or a charging device. Returning the vehicle to a resting location can include either manual or auto-pilot functionality, such as generated by the control engine. Further embodiments may include piloting the winning vehicle to a designated winner's circle or other location.

FIG. 5 illustrates one embodiment of a data flow diagram for e-sports, such as including with the gaming engine (106 of FIG. 1). The racing interactions, such as described in FIG. 2, are integrated within a gaming platform for e-sports content capture, management, and distribution.

Step 240 is to run user interface software for the e-sports platform. The user interface software can include multiple interfaces, including a first interface for racing contestants and a second interface for viewers. Moreover, the user interface software can execute on any suitable device or platform, and may include or integrate with existing viewing or interactive software application(s).

Step 242 is to engage with players and viewers. This can include user log-on or other features. Racers, individually or with teams, can register on the platform. Parties or groups can reserve vehicles or tracks, such as for a virtual gathering or a remote team-building exercise.

Engagement with players and viewers is across networked connections using existing interface and connectivity techniques.

Step 244 is generating e-sports data and content, including managing player and competition data. This data may be background or prior-event data. This data can also be specific to users or teams, as well as to events including data about the vehicles being raced, the track, track conditions, race details, etc.

E-sports data can also include data about races, flights, competitions, users assigned to different races, and other competition-specific data. For example, if a racing tournament is set-up, the data can be multiples flights for users to engage in multiple racing events leading up to a final determinative race. Further data input and interaction can include wagering or games of chance associated therewith.

Step 246 is facilitating remote-based racing competitions with e-sports players. Step 306 is similar to FIG. 4, including coordinating user interface functions for controlling specific vehicles prior to and during racing activities.

Step 248 is to distribute e-sports content. As noted in step 250, this content can be, for example, livestream content, delayed/on-demand content, commercial content, social media content, and/or related content associated with the e-sports content such as advertisement, news, ancillary racing content, wagering content, by way of example. Additional content may be included, the step 250 is list is not exclusive in nature.

The e-sports content, for example, includes sending race data and visuals to a viewer application. For example, the application may include a central window with visuals of the race itself, with sidebars with race-specific data, social data, advertising content, etc.

Step 252 is managing and updating e-sports records. This step includes not only real-time data for specific races, but also overall data relating to the e-sports activities. For example, players can compete both a race-specific level but also at a competition or season level. The data can include not only racing specifics for the event itself, but for example how the racer faired over the course of multiple races or over a season.

For step 254, where the user engages with a racing vehicle, the method may include disabling a connection to the vehicle. This can include returning the vehicle to a stable for recharging or being available for other users.

Herein, the method and system provides for decentralized remotely-controlled vehicle races via a centralized network-based engine. The inclusion of network-based controls and remotely-displaced physical vehicles being remotely controlled by the network-based controls, facilitates in-person racing events. The gaming engine therein facilitates not only the competitions, but content distribution to viewers.

FIGS. 1 through 5 are conceptual illustrations allowing for an explanation of the present invention. Notably, the figures and examples above are not meant to limit the scope of the present invention to a single embodiment, as other embodiments are possible by way of interchange of some or all of the described or illustrated elements. Moreover, where certain elements of the present invention can be partially or fully implemented using known components, only those portions of such known components that are necessary for an understanding of the present invention are described, and detailed descriptions of other portions of such known components are omitted so as not to obscure the invention. In the present specification, an embodiment showing a singular component should not necessarily be limited to other embodiments including a plurality of the same component, and vice-versa, unless explicitly stated otherwise herein. Further, the present invention encompasses present and future known equivalents to the known components referred to herein by way of illustration.

The foregoing description of the specific embodiments so fully reveals the general nature of the invention that others can, by applying knowledge within the skill of the relevant art(s) (including the contents of the documents cited and incorporated by reference herein), readily modify and/or adapt for various applications such specific embodiments, without undue experimentation, without departing from the general concept of the present invention. Such adaptations and modifications are therefore intended to be within the meaning and range of equivalents of the disclosed embodiments, based on the teaching and guidance presented herein.

What is claimed is:

1. A network-based remote control racing system comprising:
a gaming engine disposed within a data exchange network;
a vehicle control engine in communication with the gaming engine via the data exchange network, the vehicle control engine in wireless communication with a first remote control vehicle and a second remote control vehicle, wherein the first remote control vehicle and the second remote control vehicle are disposed within a race course;
a first user interfacing module running on a first mobile computing device, in communication with the gaming engine via the data exchange network;
a second user interfacing module running on a second mobile computing device, in communication with the gaming engine via the data exchange network;
the gaming engine receiving first user input commands from a first user via the first user interfacing module and transmitting the first user input commands to the vehicle control engine across the data exchange network and the gaming engine receiving second user input commands from a second user via the second user interfacing module and transmitting the second user input commands to the vehicle control engine across the data exchange network;
the vehicle control engine generating first vehicle control commands based on the first user input commands and transmitting the first vehicle control commands to the first remote control vehicle; and
the vehicle control engine generating second vehicle control commands based on the second user input commands and transmitting the second vehicle control commands to the second remote control vehicle, such that the first user competes against the second user by racing the first remote control vehicle against the second remote control vehicle in the race course.

2. The network-based remote control racing system of claim 1 further comprising:
a racing content module capturing racing content of the first remote control vehicle and the second remote control vehicle and transmitting the racing content to the gaming engine.

3. The network-based remote control racing system of claim 2 further comprising:
a plurality of gaming display modules in networked communication with the gaming engine; and
a gaming content distribution module disposed within the gaming engine, the gaming content distribution module receiving the racing content from the racing content capture module and transmitting the racing content to the plurality of gaming display modules.

4. The network-based remote control racing system of claim 1 further comprising:
a first vehicle tracking module capturing movement data of the first vehicle;
a second vehicle tracking module capturing movement data of the second vehicle;
the first vehicle tracking module transmitting the movement data of the first vehicle to the first user interfacing module such that the first user input commands are in response thereto; and
the second vehicle tracking module transmitting the movement data of the second vehicle to the second user interfacing module such that the second user input commands are in response thereto.

5. The network-based remote control racing system of claim 4 further comprising
a racing content module capturing racing content of the first remote control vehicle and the second remote control vehicle; and
the racing content module receiving and integrating the movement data of the first vehicle and the movement data of the second vehicle into the racing content and transmitting the racing content to the gaming engine.

6. The network-based remote control racing system of claim 1 further comprising:
a team content database having team content data stored therein;
the gaming engine associating the first user with a first team and the second user with a second team and accessing first team content data and second team content data from the team content database;
at least one of: the gaming engine and the vehicle control engine, providing at least a portion of the first team content data to the first remote control vehicle and at least a portion of the second team content data to the second remote control vehicle.

7. The network-based remote control racing system of claim 6, wherein the first team content data includes an image for display on first remote control vehicle.

8. The network-based remote control racing system of claim 7, wherein the image is a non-fungible token.

9. The network-based remote control racing system of claim 1, wherein the first remote control vehicle and the second remote control vehicle are at least ones of: cars, boats, drones, and planes.

10. The network-based remote control racing system of claim 1, wherein the first user interfacing module running on the first mobile computing device includes a virtual reality headset.

11. A network-based remote control racing method comprising:
receiving, from a first user via a first user interfacing module running on a first mobile computing device, a first user input accessing a gaming engine disposed within a data exchange network;
receiving, from a second user via a second user interfacing module running a second mobile computing device, a second user accessing the gaming engine;
connecting the gaming engine with a vehicle control engine in response to the first user input and the second user input;
engaging, via the vehicle control engine, a first remote control vehicle and associating the first remote control vehicle with the first user interfacing module and engaging a second remote control vehicle and associating the second remote control vehicle with the second user interfacing module, wherein the first remote control vehicle and the second remote control vehicle are disposed within a race course;
based on the first user input, generating first vehicle control commands and transmitting the first vehicle control commands to the first vehicle via the vehicle control engine; and
based on the second user input, generating second vehicle control commands and transmitting the second vehicle control commands to the second vehicle via the vehicle control engine, such that the first user competes against the second user by racing the first remote control vehicle against the second remote control vehicle in the race course.

12. The network-based remote control racing method of claim 11 further comprising:
capturing racing content of the first remote control vehicle and the second remote control vehicle via a racing content module; and
transmitting the racing content to the gaming engine.

13. The network-based remote control racing method of claim 12 further comprising:
receiving the racing content in a gaming content distribution module disposed within the gaming engine; and
transmitting the racing content to a plurality of gaming display modules in networked communication with the gaming engine.

14. The network-based remote control racing method of claim 11 further comprising:
capturing movement data of the first remote control vehicle via a first vehicle tracking module;
transmitting the movement data of the first remote control vehicle to the first user interfacing module;
capturing movement data of the second remote control vehicle via a second vehicle tracking module; and
transmitting the movement data of the second remote control vehicle to the second user interfacing module.

15. The network-based remote control racing method of claim 14 further comprising:
capturing racing content of the first remote control vehicle and racing content of the second remote control vehicle;
integrating the racing content of the first remote control vehicle with the movement data of the first remote control vehicle;
integrating the racing content of the second remote control vehicle with the movement data of the second remote control vehicle; and
transmitting the racing content of the first remote control vehicle, the movement data of the first remote control vehicle, the racing content of the second remote control vehicle, and the movement data of the second remote control vehicle to the gaming engine.

16. The network-based remote control racing method of claim 11 further comprising:
associating, in the gaming engine, the first user with a first team and the second user with a second team;
accessing a team content database and retrieving first team content data and second team content data therefrom; and
providing at least a portion of the first team content data to the first remote control vehicle and providing at least a portion of the second team content data to the second remote control vehicle.

17. The network-based remote control racing method of claim 16, wherein the first team content data includes an image for display on first remote control vehicle.

18. The network-based remote control racing method of claim 17, wherein the image is a non-fungible token.

19. The network-based remote control racing method of claim 11, wherein the first remote control vehicle and the second remote control vehicle are at least ones of: cars, boats, drones, and planes.

20. The network-based remote control racing method of claim 11, wherein the wherein the first user interfacing module running on the first mobile computing device includes a virtual reality headset.
